(19) United States
(12) Patent Application Publication
(10) Pub. No.: US 2007/0255498 A1
(43) Pub. Date: Nov. 1, 2007

(54) Systems and methods for determining threshold warning distances for collision avoidance

(75) Inventors: Michael Sean McDaniel, Peoria, IL (US); Dexter Grant Travis, Hopedale, IL (US); Robert Martin Coats, Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 11/412,881

(22) Filed: Apr. 28, 2006

(51) Int. Cl. G06G 7/78; G06F 17/10

(52) U.S. Cl. 701/301; 701/300; 340/436

(57) ABSTRACT

A method for determining a threshold distance for a collision warning system includes receiving, from at least one sensing device, data indicative of a change of position of a target object relative to a host machine. The method further includes receiving data indicative of a velocity of the host machine and determining a closing rate associated with a rate of change of distance between the host machine and the target object based on the data indicative of a change of position of the target object relative to the host machine. The method also includes calculating a velocity of the target object based on the velocity of the host machine and the closing rate. The method further includes determining a threshold distance between the host machine and the target object, wherein the threshold distance is a function of the velocity of the target object, the velocity of the host machine, and a reaction time associated with one or more of the host machine velocity, the target object velocity, or an environmental condition. The method also includes providing a signal indicative of the threshold distance to an alarm system associated with a collision warning system.

### TECHNICAL FIELD

This disclosure relates generally to collision warning systems and, more particularly, to systems and methods for adaptively determining threshold warning distances for collision warning systems.

### BACKGROUND

Collision warning systems are used in a variety of machines, such as aircraft, automotive vehicles, watercraft, etc. These systems often include sensing devices, such as optical sensors, radar systems, etc. that detect the range, position, movement direction, and/or size of objects in proximity to the machine. For example, some conventional collision warning systems calculate a stopping distance associated with the machine based on the velocity of the machine and provide an alarm when an object in proximity to the machine lies within a threshold range.

Conventional warning systems may be limited in their methods for determining the appropriate time to provide warning signals. For example, some of these systems provide an alarm each time an object enters an area associated with the stopping distance of the machine, regardless of the velocity of the object. As a result, objects that enter the machine's stopping distance but are traveling in the same direction at a safe distance from the machine may trigger an alarm, falsely indicating a potential for collision.

To minimize false alarms while providing timely warning information to a machine operator, collision warning systems have evolved to detect a speed associated with a target object. For instance, at least one collision avoidance system has been developed to provide a warning signal to an operator of a vehicle based on a speed of an object relative to the vehicle. For example, U.S. Pat. No. 4,257,703 (“the '703 patent”) to Goodrich describes a collision avoidance system that includes an image sensor configured to detect images associated with an object. The system may convert the images to electrical signals to determine a rate-range ratio associated with changes in the detected images over time. The rate-range ratio may be a function of the relative velocity of the object in relation to the vehicle. The system of the '703 patent may include a signal means for generating a collision avoidance signal based on the rate-range rate of the detected object compared to a value indicative of a time necessary for the vehicle operator to react to the perceived collision.

Although the collision avoidance system of the '703 patent may provide a warning signal based on the velocity of an object relative to a vehicle, it may not be sufficient. For example, the system of the '703 patent only provides a warning signal when the rate-range ratio exceeds a value indicative of the time required for an operator of the vehicle to avoid a collision. However, it may not factor in a reaction time associated with an operator of a target object. Furthermore, the system of the '703 patent provides a warning signal based solely on velocity, regardless of certain other operational aspects of the vehicle such as, for example, the grade or angle of inclination of the vehicle. As a result, a vehicle traveling on an incline grade may require less stopping distance and/or reaction time than a vehicle traveling on a declining grade.

Additionally, the system of the '703 patent may not accurately determine a threshold condition for providing a warning signal. For instance, although the system of the '703 patent may provide a warning system if the rate-range ratio (i.e., closure speed) exceeds a predetermined reaction time associated with the operator of the vehicle, it does not, however, differentiate between a direction of travel of a detected object, which could potentially result in erroneous warning signals. For example, an object that enters an area associated with the stopping distance of the vehicle may trigger a warning, regardless of whether the object is traveling in the same or opposite direction as the vehicle. As a result, warning signals associated with objects that are traveling in the same direction as the vehicle may be triggered unnecessarily, while warning signals associated with objects traveling in the opposite direction as the vehicle may not provide adequate operator reaction time.

The presently disclosed systems and methods for determining threshold warning signals are directed toward overcoming one or more of the problems set forth above.

### SUMMARY OF THE INVENTION

In accordance with one aspect, the present disclosure is directed toward a method for determining a threshold distance for a collision warning system. The method may include receiving, from at least one sensing device, data indicative of a change of position of a target object relative to a host machine. The method may further include receiving data indicative of a velocity of the host machine. The method may also include determining a closing rate associated with a rate of change of distance between the host machine and the target object based on the data indicative of a change of position of the target object relative to the host machine. The method may further include estimating a velocity of the target object based on the velocity of the host machine and the closing rate. The method may also include determining a threshold distance between the host machine and the target object, wherein the threshold distance is a function of the velocity of the target object, the velocity of the host machine, an angle of inclination of each of the host machine and the target object, and a reaction time associated with an environmental condition.

According to another aspect, the present disclosure is directed toward a collision warning system. The collision warning system may include at least one sensing device. The sensing device may be configured to collect data indicative of a change of position of a target object relative to a host machine. The system may also include a controller coupled to the at least one sensing device. The controller may be configured to receive the first and second sets of position data associated with the target object. The controller may also be configured to receive data indicative of a velocity of the host machine. The controller may be further configured to determine a closing rate associated with a rate of change of distance between the host machine and the target object based on the data indicative of a change of position of the target object relative to the host machine. The controller may also be configured to estimate a velocity of the target object based on the velocity of the host machine and the closing rate. The controller may be further configured to determine a threshold distance between the host machine and the target object, wherein the threshold distance is a function of the velocity of the target object, the velocity of the host machine, an angle of inclination of each of the host machine and the target object, and a reaction time associated with an environmental condition.

In accordance with yet another aspect, the present disclosure is directed toward a computer readable medium for use on a computer system, the computer readable medium having computer executable instructions for performing a method for determining a threshold distance for a collision warning system. The method may include receiving, from at least one sensing device, data indicative of a change of position of a target object relative to a host machine. The method may further include receiving data indicative of a velocity of the host machine. The method may also include determining a closing rate associated with a rate of change of distance between the host machine and the target object based on the data indicative of a change of position of the target object relative to the host machine. The method may further include estimating a velocity of the target object based on the velocity of the host machine and the closing rate. The method may also include determining a threshold distance between the host machine and the target object, wherein the threshold distance is a function of the velocity of the target object, the velocity of the host machine, an angle of inclination of each of the host machine and the target object, and a reaction time associated with an environmental condition.

### BRIEF DESCRIPTION OF THE DRAWINGS

FIG. 1 illustrates an exemplary environment in which methods consistent with the disclosed embodiments may be implemented;

FIG. 2 illustrates an exemplary controller consistent with certain disclosed embodiments;

FIG. 3 illustrates an exemplary disclosed method of operation associated with an exemplary collision warning system; and

FIG. 4 illustrates an exemplary method for calculating a threshold distance consistent with the disclosed embodiments.

### DETAILED DESCRIPTION

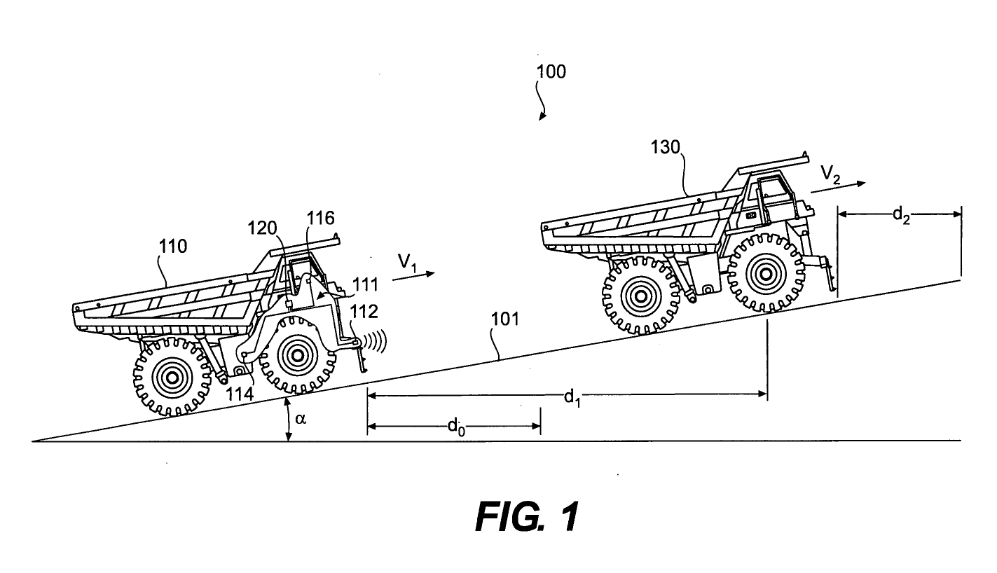

FIG. 1 illustrates an exemplary environment 100 in which processes and principles consistent with the disclosed embodiments may be implemented. As shown in FIG. 1, environment 100 may include a host machine 110 traveling at a velocity, V₁, and a target object 130 traveling at a velocity, V₂, wherein the target object is at a distance d₀ from host machine 110. Environment 100 may include a traveling surface 101 with a grade a associated with an angle of inclination of traveling surface 101. Although target object 130 is illustrated as a track-type tractor machine it is contemplated that target object 130 may include any mobile or fixed object located within a detectable proximity to host machine 110.

Machine, as the term is used herein, may include any type of fixed or mobile machine configured to perform a task associated with an industry such as farming, transportation, construction, mining, energy exploration, power generation, etc. and operates between or within environments (e.g., construction site, mining site, power plant, etc.). Non-limiting examples of fixed machines include an engine system, a drill rig, etc. that operates in a plant or off-shore environment (e.g., off-shore drilling platform). Non-limiting examples of mobile machines may include commercial or industrial machines such as on-highway or off-highway vehicles, trucks, cranes, earth moving machines, backhoes, track-type tractors, motor graders, haulers, dump trucks, excavators, aircraft, marine vessels, farming equipment, or any type of moveable machine that operates in a work environment. As shown in FIG. 1, host machine 110 includes a fixed-wheel hauler machine. It is contemplated, however, that host machine 110 may include any type of mobile or fixed machine. The number and types of machines shown in FIG. 1 are exemplary only, and not intended to be limiting.

As explained above, target object 130 may include any object that may be located in detectable proximity to host machine 110, thus presenting a potential collision hazard for host machine 110. For example, target object 130 may include one or more mobile or fixed objects such as machines, people, animals, impediments such as walls, rocks, boulders, etc., or any other object that host machine 110 may detect as a potential collision hazard. According to one embodiment, target object 130 may include a machine traveling in the path of, and in a direction relative to, host machine 110. Although target object 130 is illustrated as traveling in the same path and direction as host machine 110, it is contemplated that target object 130 may be located adjacent to, behind, and/or diagonal from host machine 110 and may be stationary, traveling in a path incident to, or traveling in an direction or path opposite host machine 110 and/or a path associated with host machine 110.

Host machine 110 may include one or more safety devices for operating within environment 100. For example, host machine 110 may include, among other things, a collision warning system 111 configured to determine whether a detected object, such as target object 130, presents a potential collision hazard for host machine 110. It is contemplated that host machine 110 may include additional, fewer, and/or different elements than those listed above.

Collision warning system 111 may be operatively coupled to host machine 110 and include one or more components that cooperate to detect potential collision hazards associated with host machine 110. For example, collision warning system 111 may include, among other things, one or more sensing devices 112, a velocity monitoring device 114, an alarm system 116, and a controller 120. Collision warning system 111 may constitute a standalone system associated with host machine 110. Alternatively, collision warning system 111 may coincide with an electronic control unit associated with host machine 110. It is contemplated that collision warning system 111 may include addition, fewer, and/or different components than those listed above. For example, instead of comprising alarm system 116, collision warning system 111 may be communicatively coupled to an on-board information console associated with host machine 110.

Sensing devices 112 may include one or more components for monitoring a position, velocity, acceleration, and/or distance associated with target object 130 relative to host machine 110. For example, sensing devices 112 may include one or more of an optical, infrared, sonar, radar, Doppler, and/or microwave detection device that periodically or continuously monitors areas in relative proximity to host machine 110. Although sensing device 112 is illustrated as monitoring an area substantially in front of host machine 110 (i.e., illustrating a uni-directional sensing device 110), it is contemplated that sensing devices 112 may include an combination of omni-directional or directional (uni-directional, bi-directional, etc.) devices. Furthermore, multiple sensing devices 112 may be provided, each configured to monitor a particular area or direction (e.g., behind, adjacent to, etc.) associated with host machine 110. It is contemplated that sensing devices 112 may be arranged in a variety of configurations. Accordingly, particular configurations and arrangements of sensing devices 112 described above are exemplary only and not intended to be limiting.

Sensing devices 112 may also include one or more components for determining a grade or inclination associated with traveling surface. For example, sensing devices 112 may include any device suitable for measuring or calculating grade, tilt, or slope such as, for example an laser-level sensor, a tilt sensor, an inclinometer (e.g., bubble-type, etc.), or any other suitable device for measuring surface grade. Grade sensing devices may provide grade information as a percentage, as a degree measure, as an angle of inclination, or as a slope associated with the measure of an increase in vertical distance with respect to a horizontal distance (e.g., “rise/run”).

Velocity monitoring device 114 may include one or more devices for determining a velocity associated with host machine 110. For example, velocity monitoring device 114 may include a mechanical or computerized device coupled to a transmission of host machine 110 and configured to determine the velocity of host machine 110 based on the distance traveled over a given time period. Alternatively, velocity monitoring device 114 may be communicatively coupled to a speedometer associated with host machine 110 and configured to monitor the speed of the vehicle as determined by the speedometer.

Alarm system 116 may include one or more warning devices configured to notify an operator of host machine 110 in response to a warning signal received from controller 120. For example, alarm system 116 may include one or more of an audible alarm, a visual alarm, an audio-visual alarm, a vibrating alarm, or any other suitable warning device. According to one embodiment, alarm system 116 may include certain signal processing capabilities to compare a signal indicative of a distance, d₀, between host machine 110 and target object 130 with a threshold warning distance, D, and activate the alarm based on an output associated with the comparison.

Controller 120 may be communicatively coupled to each of sensing devices 112, velocity monitoring device 114, and alarm system 116 via one or more communication lines. Communication lines may include any type of wireless or wireline communication medium such as, for example, a wireless link, Bluetooth link, optical communication link, electrical wires, an infrared link, or any other suitable medium for communicating data associated with collision warning system 111. Controller 120 may be in direct communication with each of sensing devices 112, velocity monitoring device 114, and alarm system 116. Alternatively, controller 120 and other devices associated with collision warning system 111 may be coupled to a common communication bus associated with collision warning system 111.

Controller 120 may be operatively coupled to sensing devices 112 and configured to receive information associated with target object 130 and/or environment 100 that may be provided by sensing devices 112. Controller 120 may receive the information automatically (i.e., in real-time) as sensing devices 112 collect the information. Alternatively and/or additionally, controller 120 may provide a data query to sensing devices 112. Controller 120 may receive information in response to the query. Controller 120 may be configured to store, analyze, process, evaluate, and distribute information received from sensing devices 112.

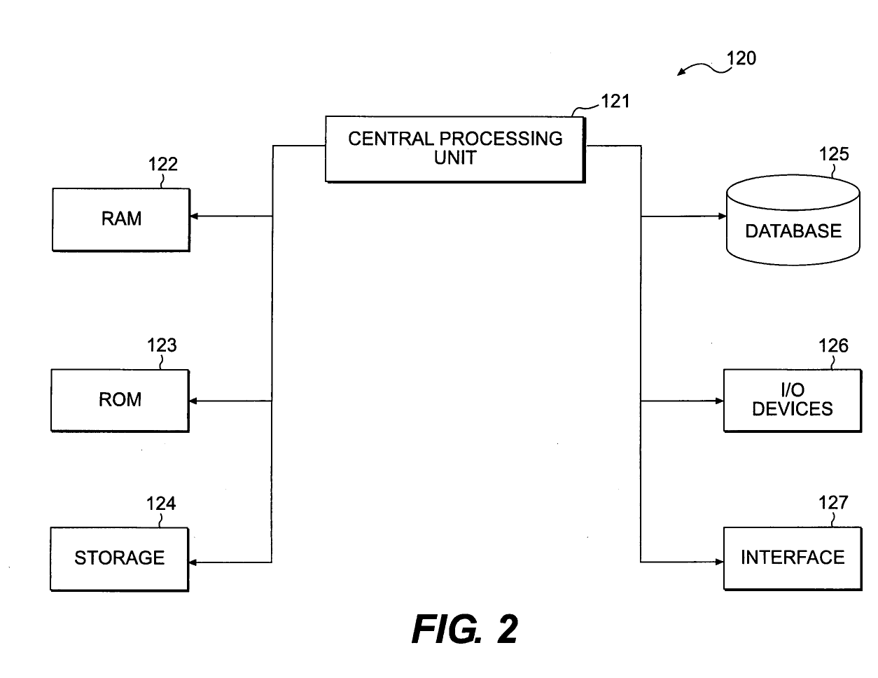

Controller 120, as diagrammatically illustrated in FIG. 2, may include one or more hardware and/or software components configured to collect, monitor, store, analyze, evaluate, distribute, report, process, record, and/or sort information associated with system 100. For example, controller 120 may include one or more hardware components such as, for example, a central processing unit (CPU) 121, a random access memory (RAM) module 122, a read-only memory (ROM) module 123, a storage 124, a database 125, one or more input/output (I/O) devices 126, and an interface 127. Alternatively and/or additionally, controller 120 may include one or more software components such as, for example, a computer-readable medium including computer-executable instructions for performing a method associated with collision warning system 111. It is contemplated that one or more of the hardware components listed above may be implemented using software. For example, storage 124 may include a software partition associated with one or more other hardware components of controller 120. Controller 120 may include additional, fewer, and/or different components than those listed above. It is understood that the components listed above are exemplary only and not intended to be limiting.

CPU 121 may include one or more processors, each configured to execute instructions and process data to perform one or more functions associated with controller 120. As illustrated in FIG. 1, CPU 121 may be communicatively coupled to RAM 122, ROM 123, storage 124, database 125, I/O devices 126, and interface 127. CPU 121 may be configured to execute sequences of computer program instructions to perform various processes, which will be described in detail below. The computer program instructions may be loaded into RAM 122 for execution by CPU 121.

RAM 122 and ROM 123 may each include one or more devices for storing information associated with an operation of controller 120 and/or CPU 121. For example, ROM 123 may include a memory device configured to access and store information associated with controller 120, including information for identifying, initializing, and monitoring the operation of one or more components and subsystems of controller 120. RAM 122 may include a memory device for storing data associated with one or more operations of CPU 121. For example, ROM 123 may load instructions into RAM 122 for execution by CPU 121.

Storage 124 may include any type of mass storage device configured to store information that CPU 121 may need to perform processes consistent with the disclosed embodiments. For example, storage 124 may include one or more magnetic and/or optical disk devices, such as hard drives, CD-ROMs, DVD-ROMs, or any other type of mass media device.

Database 125 may include one or more software and/or hardware components that cooperate to store, organize, sort, filter, and/or arrange data used by controller 120 and/or CPU 121. For example, database 125 may store predetermined operator reaction time information associated with different conditions (e.g., fog, rain, snow, time-of-day, etc.) at different speeds. CPU 121 may access the information stored in database 125 to determine a threshold warning distance for collision warning system 111. It is contemplated that database 125 may store additional and/or different information than that listed above.

I/O devices 126 may include one or more components configured to communicate information with a user associated with controller 120. For example, I/O devices may include a console with an integrated keyboard and mouse to allow a user to input parameters associated with controller 120. I/O devices 126 may also include a display including a graphical user interface (GUI) for outputting information on a monitor. I/O devices 126 may also include peripheral devices such as, for example, a printer for printing information associated with controller 120, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 127 may include one or more components configured to transmit and receive data via a communication network, such as the Internet, a local area network, a workstation peer-to-peer network, a direct link network, a wireless network, or any other suitable communication platform. For example, interface 127 may include one or more modulators, demodulators, multiplexers, demultiplexers, network communication devices, wireless devices, antennas, modems, and any other type of device configured to enable data communication via a communication network.

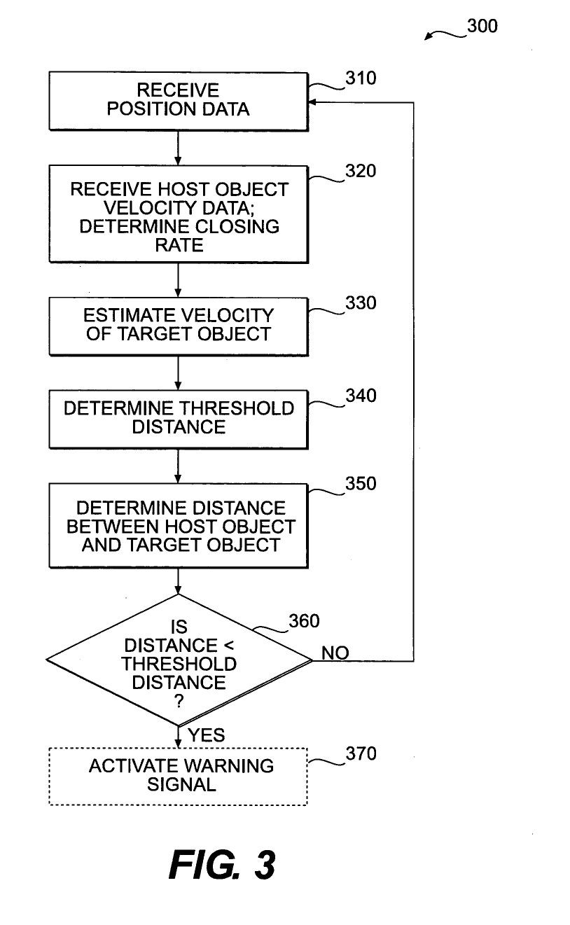

Processes and methods consistent with the disclosed embodiments may allow collision warning systems to accurately identify target objects that may constitute legitimate collision hazards and adapt to positional and speed changes associated with one or more target objects. FIG. 3 provides a flowchart 300 illustrating an exemplary method of operation of collision warning system 111. The method may include receiving data indicative of the change of position of target object 130 relative to host machine 110 (Step 310). According to one embodiment, this data may be collected by one or more sensing devices 112. For example, sensing devices 112 may include one or more devices that calculate a Doppler shift to determine the change in position of target object 130.

Alternatively and/or additionally, sensing devices 112 may be configured to receive at a first time, T₁, a first set of position data associated with target object 130 detected by collision warning system 111. For example, controller 120 may receive data collected by the sensing devices 112 indicative of a position associated with target object 130 relative to host machine 110. This data may be received automatically (i.e., in real-time), or in response to a query provided by controller 120. Position data, as the term is used herein, refers to information associated with a position of target object 130 relative to host machine 110 such as, for example, GPS data (e.g., latitude and longitude coordinates, etc.), distance, etc. After the first set of position data has been received, a second set of position data associated with target object 130 may be received at a second time, T₂. According to one embodiment, collision warning system 111 may be configured to receive second (and subsequent) sets of position data associated with target object 130 at predetermined time intervals. For example, controller 120 associated with collision warning system 111 may cause one or more sensing devices 112 to periodically pulse the area surrounding host machine 110 and receive position data in response to the pulse.

Upon receiving data indicative of the change of position of target object 130 relative to host machine 110, the closing rate, Rᵣ, between host machine 110 and target object 130 may be calculated and data indicative of the velocity of host machine 110 may be received from velocity monitoring device 114 (Step 320). Closing rate, as the term is used herein, refers to the rate at which host machine 110 approaches target object 130. For example, closing rate may be determined through analysis of position data received from sensing devices 112. For example, sensing devices may provide the data indicative of the change in position of target object 130 respective of host machine 110. Controller 120 may analyze the received data to determine the closing rate between host machine 110 and target object 130. According to one embodiment, sensing devices 112 may include radar devices that determine a Doppler shift based on a frequency of electromagnetic waves reflected by target object 130.

According to another embodiment, controller 120 may execute software that determines, based on the received position data, a change of position associated with target object 130 relative to host machine 110 with respect to time using the formula:

$${R}_{r} = \frac{Δ P}{Δ T}$$

where ΔP is the change in the second set of position data associated with target object 130 relative to the first set of position data calculated with respect to time. Further, controller 120 may receive velocity data associated with host machine 130 from velocity monitoring device 114. Controller 120 may receive the velocity data automatically or in response to a query provided to velocity monitoring device 114. Controller 120 may determine a velocity, V₁, associated with host machine 110 based on the received velocity data.

Alternatively and/or additionally, other methods for determining range rate may be implemented without departing from the scope of the present disclosure. It is also contemplated that certain processes and methods, although described as being associated with sensing devices 112 and/or controller 120, may be implemented using various combinations and permutations thereof. For example, range rate may be exclusively determined by sensing devices 112 adapted as radar devices configured to determine range rate using Doppler-shift calculations. Thus, the methods described for determining range rate are exemplary only and not intended to be limiting. Those of ordinary skill will recognize that range rate determination may be performed by other devices, software systems, or manually without departing from the scope of the present disclosure.

Once the closing rate has been determined and the velocity data has been received, a velocity, V₂, associated with target object 130 may be estimated (Step 330). For example, controller 120 may estimate the velocity of target object 130 based on the velocity of the host machine 110 and the determined closing rate between host machine 110 and target machine 130, using the following formula:
V₂=V₁−Rᵣ.
As can be seen from the formula above, the velocity associated with the target object 130, V₂, is zero when the closing rate, Rᵣ, is equal to the velocity of the host machine, V₁, which indicates that target object 130 is neither approaching nor retreating (i.e., stationary, moving in a direction substantially orthogonal, etc.) with respect to host machine 110.

Once the velocity of the target object has been estimated, a threshold warning distance, D, may be calculated (Step 340). For example, controller 120 may calculate the threshold warning distance based on the respective velocities of host machine 110 and target object 130, as well as a current stopping distance required by each object. This threshold distance is typically associated with the minimum distance that may be required by host machine 110 to avoid a collision. According to one embodiment, threshold distance may be determined with respect to target object 130. Processes and method for calculating the threshold warning distance will be described in detail below.

Once the threshold distance has been determined, an actual distance between host machine 110 and target object 130 may be determined (Step 350). For example, sensing devices 112 associated with controller 120 may emit a monitoring signal, such as a sonar, microwave, optical, or infrared signal. Sensing devices 112 may subsequently collect signals corresponding to reflections of the emitted signal associated with target object 130. Controller 120 may determine, based on the reflected signals collected by sensing devices, a distance of target object 130 relative to host machine 110. It is contemplated that the order of the steps in the exemplary method may change and that, for example, the actual distance may be determined before, or substantially simultaneous to, the threshold distance.

Once the distance between host machine 110 and target object 130 has been determined, the actual distance may be compared with the threshold distance (Step 360). For example, controller 120 may compare the actual distance to the threshold distance. If the actual distance is less than the threshold distance (Step 360: Yes), a warning signal may be activated by controller 120 and/or alarm system 116 (Step 370). Alternatively, if the actual distance is not less than the threshold distance (Step 360: No), collision warning system 111 may continue monitoring the area surrounding host machine 120.

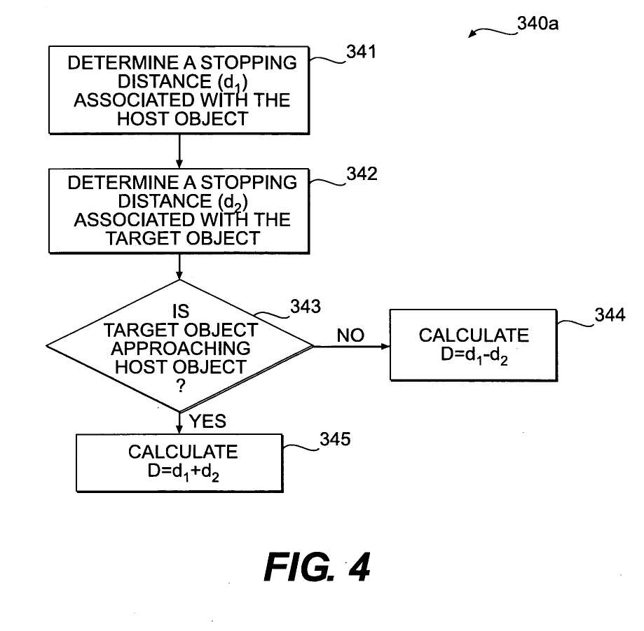

An aspect associated with collision warning system 111 is the manner in which the threshold distance is determined. FIG. 4 provides a flowchart 340a, illustrating an exemplary method for determining the threshold distance associated with the operation of collision avoidance system 111. The first step in calculating the threshold distance is to determine a stopping distance, d₁, associated with host machine 110 (Step 341). The stopping distance refers to the minimum distance that may be required for a particular moving object, under certain operating conditions, to decelerate to a complete stop. Controller 120 may determine the stopping distance using the following formula:

$${d}_{1} = \frac{{V}_{1}^{2}}{488 - 2.6 α}$$

where V₁ represents the velocity of host machine 110 and a represents the percent grade associated with traveling surface 101 on which host machine 110 is traveling. This formula, defined in the ISO 3450 standard for the testing of braking systems for earth moving machines, is exemplary only and not intended to be limiting. Any suitable stopping distance formula, process, or method may be used to determine stopping distance associated with host machine 110.

Once the stopping distance associated with host machine 110 has been determined, a stopping distance associated with target object 130 may be determined (Step 342). For instance, controller 120 may determine the stopping distance, d₂, associated with target object 130 (when target object 130 is embodied by another earth-moving machine), by applying the formula for d₁, as above, and substituting the velocity of the target object, V₂, for V₁ of the above expression. Again, it should be noted that any appropriate method or formula for calculating stopping distance may be used, insofar as an object velocity and surface grade are accounted for. It is contemplated that, although stopping distance for target object 130 is described as being determined after stopping distance of host machine 110, the determination of stopping distance may be performed in any order. Alternatively and/or additionally, stopping distances associated with host machine 110 and target object 130 may be determined substantially simultaneously.

Once the stopping distances for the respective objects have been calculated, the movement of target object 130 may be analyzed to determine whether target object 130 is approaching host machine 110 (Step 343). For example, controller 120 may determine that target object 130 is moving in the opposite direction as host machine 110 if the closing rate, Rᵣ, is greater than the velocity, V₂, of host machine 110. Similarly, if the closing rate is less than or equal to the velocity of host machine, controller 120 may determine that target object 130 is not approaching host machine 110.

If target object 130 is approaching host machine 110 (Step 343: Yes), threshold distance, D, may be determined as a sum of host machine stopping distance, d₁, target object stopping distance, d₂, and a reaction time associated with each of host machine 110 and target object 130 (Step 345) according to the formula:

$$D = \frac{2 {V}_{1}^{2} - 2 {V}_{1} {R}_{r} + {R}_{r}^{2}}{48 - 2.6 α} + \frac{t {V}_{1} + t {V}_{2}}{3.6}$$

where t represents the reaction time associated with an operator of a vehicle based on conditions associated with the machine environment. This value may be predetermined, based on test data for a particular vehicle, and is usually defined on a worst-case basis (e.g., for different types of vehicles with different parameters, the reaction time for both vehicles may be assigned the higher required reaction time of the two vehicles).

It is contemplated that various values associated with reaction time may be stored in database 125 associated with controller 120. Database 125 may contain a matrix of reaction times associated with various speeds of host machine 110 and/or a target object 130. Alternatively and/or additionally, database 125 may contain reaction times associated with various conditions associated with the work environment (e.g., climate, weather, temperature, humidity, visibility, traction, etc.) Controller 120 may be coupled to one or more sensing devices that monitor various environmental conditions to automatically determine which reaction time value is appropriate based on the environmental conditions. Controller 120 may then estimate, based on a speed associated with host machine 110, a suitable reaction time associated with the machine based on the monitored environmental condition. If target object 130 is determined to be approaching host machine 110, an arbitrary time buffer may be added to the calculation of reaction time to provide additional warning time to account for unexpected acceleration of target object 130.

If target object is not approaching host machine 110 (Step 343: No), threshold distance, D, may be determined as the difference between the host machine stopping distance and the target object stopping distance (Step 344), according to the following formula:

$$D = \frac{2 {V}_{1} {R}_{r} - {R}_{r}^{2}}{48 - 2.6 α} + \frac{t {V}_{1}}{3.6} .$$

For example, controller 120 may determine that target object 130 is stationary with respect to host machine 110. Controller 120 may then calculate the threshold distance using the above equation. As can be seen from the expression above, only reaction time associated with host machine 110 may be required, as a target object that is not approaching host machine 110 may not have a corresponding reaction time with respect to host machine 120. Further, in cases where target object 130 does not approach host machine 110, threshold distance, D, may be independent of velocity, V₂, of target object 130.

Once a threshold distance associated has been determined, it may be stored in memory for use by collision warning system 111, as illustrated in flowchart 300 of FIG. 3. As previously explained, certain disclosed methods for determining a stopping distance associated with each of host machine 110 and target object 130, such as those described above, are exemplary only and not intended to be limiting. Thus, any suitable formula, expression, device, or process for determining a stopping distance may be used, without departing from the scope of the present disclosure.

### INDUSTRIAL APPLICABILITY

Although the disclosed collision warning system 111 and methods are described in connection with moveable machines, it is contemplated that collision warning system 111 and associated methods may be implemented in any system that requires reliable and efficient warnings of a potential collision situation. Specifically, processes consistent with the disclosed embodiments provide a warning system that not only relies on a velocity and reaction time associated with a host machine, but also relies on a velocity associated with a target object.

The presently disclosed collision warning system, and methods associated therewith, may have several advantages. For example, collision warning system 111 determines a velocity associated with a target object and calculates a threshold distance based on the target object velocity. By providing a collision warning system in which threshold distance may be variable with respect to a target object speed, accuracy of alarms warning of potential collisions may be increased when compared with conventional systems that rely on threshold distances that are constant, predetermined, or based solely on a speed of the host machine. As a result, a different warning threshold may be determined for target objects approaching (and/or accelerating) toward host machine and objects that are traveling in the same direction (or stationary) with respect to host machine.

In addition, the presently disclosed collision warning system may provide additional safeguards when compared with conventional warning systems. For example, because threshold distance may be determined based on certain operational characteristics external to either of host or target object (i.e., environmental characteristics, grade or slope of landscape, etc.), alarm timing and/or intervals may be adjusted to provide different reaction times for an operator of host machine based on operational conditions associated with environment 100. As a result, certain conditions such as, for example, inclement weather, steep slopes, low visibility, etc. may be appropriately accounted for using methods consistent with the disclosed embodiments.

It will be apparent to those skilled in the art that various modifications and variations can be made to the disclosed collision warning system and associated method. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for determining a threshold distance for a collision warning system, comprising:
receiving, from at least one sensing device, data indicative of a change of position of a target object relative to a host machine;
receiving data indicative of a velocity of the host machine;
determining a closing rate associated with a rate of change of distance between the host machine and the target object based on the data indicative of a change of position of the target object relative to the host machine;
estimating a velocity of the target object based on the velocity of the host machine and the closing rate; and
determining a threshold distance between the host machine and the target object, wherein the threshold distance is a function of the velocity of the target object, the velocity of the host machine, and a reaction time associated with one or more of the host machine velocity or the target object velocity.

2. The method of claim 1, further including determining a distance between the host machine and the target object based on one or more of the data indicative of a change of position of the target object relative to the host machine and the determined closing rate.

3. The method of claim 2, wherein determining a distance between the host machine and the target object includes:
receiving the signal indicative of the threshold distance;
providing a threshold warning signal if the distance between the host machine and the target object is less than the threshold distance.

4. The method of claim 1, further including determining an angle of inclination associated with the host machine.

5. The method of claim 4, wherein determining the threshold distance further includes determining a stopping distance associated with the host machine based on the velocity of the host machine and the angle of inclination associated with the host machine.

6. The method of claim 5, wherein determining the threshold distance further includes determining whether the target object is approaching the host machine.

7. The method of claim 6, wherein determining the threshold distance further includes:
calculating, if the target object is approaching the host machine, the threshold distance as a sum of the stopping distance associated with the host machine and the stopping distance associated with the target object; and
calculating, if the target object is not approaching the host machine, the threshold distance as a difference between the stopping distance associated with the host machine and the stopping distance associated with the target object.

8. The method of claim 1, wherein the reaction time includes a predetermined value obtained from a database associated with the controller.

9. The method of claim 1, wherein the reaction time is estimated based on one or more environmental conditions.

10. A collision warning system, comprising:
at least one sensing device configured to:
collect data indicative of a change of position of a target object relative to a host machine; and
a controller coupled to the at least one sensing device and configured to:
receive the data indicative of a change of position of a target object relative to a host machine;
receive data indicative of a velocity of the host machine;
determine a closing rate associated with a rate of change of distance between the host machine and the target object based on the data indicative of a change of position of a target object relative to a host machine;
estimate a velocity of the target object based on the velocity of the host machine and the closing rate; and
determine a threshold distance between the host machine and the target object, wherein the threshold distance is a function of the velocity of the target object, the velocity of the host machine, and a reaction time associated with one or more of the host machine velocity or the target object velocity.

11. The warning system of claim 10, wherein the controller is further configured to determine a distance between the host machine and the target object based on one or more of the data indicative of a change of position of the target object relative to the host machine and the determined closing rate.

12. The warning system of claim 11, further including an alarm system in communication with the controller and configured to:
receive a signal indicative of the threshold distance from the controller;
provide a threshold warning signal if the distance between the host machine and the target object is less than the threshold distance.

13. The warning system of claim 12, wherein the threshold warning signal includes one or more of an audible alarm, a visual alarm, or a vibrating alarm.

14. The warning system of claim 10, wherein the at least one sensing device is configured to measure the angle of inclination associated with the host machine.

15. The warning system of claim 14, wherein the controller is configured to determine the threshold distance by determining a stopping distance associated with the host machine based on the velocity of the host machine and the angle of inclination associated with the host machine.

16. The warning system of claim 15, wherein the controller determines the threshold distance based on whether the target object is approaching the host machine.

17. The warning system of claim 16, wherein the controller determines the threshold distance by:
calculating, if the target object is approaching the host machine, the threshold distance as a sum of the stopping distance associated with the host machine and the stopping distance associated with the target object; and
calculating, if the target object is not approaching the host machine, the threshold distance as a difference between the stopping distance associated with the host machine and the stopping distance associated with the target object.

18. The warning system of claim 10, wherein the reaction time includes a predetermined value obtained from a database associated with the controller.

19. The warning system of claim 10, wherein the reaction time is estimated based on one or more environmental conditions.

20. A computer readable medium for use on a computer system, the computer readable medium having computer executable instructions for performing a method comprising:
receiving data indicative of a change of position of a target object relative to a host machine;
receiving data indicative of a velocity of the host machine;
determining a closing rate associated with a rate of change of distance between the host machine and the target object based on the data indicative of a change of position of a target object relative to a host machine;
estimate a velocity of the target object based on the velocity of the host machine and the closing rate; and
determining a threshold distance between the host machine and the target object, wherein the threshold distance is a function of the velocity of the target object, the velocity of the host machine, and a reaction time associated with one or more of the host machine velocity, the target object velocity, or an environmental condition.
